(19) United States
(12) Patent Application Publication
(10) Pub. No.: US 2007/0018356 A1
(43) Pub. Date: Jan. 25, 2007

(54) Hydraulic pressure molding device and hydraulic pressure molding method

(76) Inventors: Katsuaki Nakamura, Fukuoka (JP); Zenji Horita, Fukuoka (JP); Koji Neishi, Fukuoka (JP); Michihiko Nakagaki, Fukuoka (JP); Kenji Kaneko, Fukuoka (JP)

Correspondence Address: JORDAN AND HAMBURG LLP, 122 EAST 42ND STREET, SUITE 4000, NEW YORK, NY, 10168, US

(21) Appl. No.: 10/570,191

(22) PCT Filed: Aug. 27, 2004
(86) PCT No.: PCT/JP04/12408

§ 371 Date: Jun. 7, 2006

(30) Foreign Application Priority Data
Aug. 28, 2003 (JP) 2003-303909

(51) Int. Cl. B28B 7/32; B29C 43/36

(52) U.S. Cl. 264/314; 264/322; 425/389; 425/405.1

(57) ABSTRACT

A hydraulic pressure molding device and a hydraulic pressure molding method for molding a molded body of a specified shape by holding a material plate by a first mold pressing the material plate with a pressurized liquid medium and a second mold in which a molding recessed surface of a specified shape is formed and pressing the material plate with the liquid medium to bring the material plate into contact with the molding recessed surface. The second mold comprises deformation resistance adjusting means locally differentiating the deformation resistance of the material plate. The deformation resistance adjusting means are formed of a local cooling means locally cooling the material plate and a local heating means locally heating the material plate. In addition, the deformation resistance adjusting means are formed movable forward and backward relative to the second mold.

### BACKGROUND OF THE INVENTION

The present invention relates to a liquid pressure molding device and a liquid pressure molding method which form a plate-like material plate into a predetermined shape by press forming.

Conventionally, as an example of a molding method which molds a material plate made of a plate material such as a metal plate and the like into a predetermined shape, there has been known press forming which presses a material plate using a die.

As one example of such press forming, a liquid pressure molding device described in Japanese patent laid-open Hei6 (1994)-304672 has been used.

In this liquid pressure molding device, a liquid medium for pressing the material plate is supplied into a first die under high pressure, a molding recessed surface having a predetermined shape is formed in a contact surface of the second die which comes into contact with the material plate, the material plate is clamped between the first die and the second die, and the liquid medium is filled into the first die so as to bring the material plate into pressure contact with the molding recessed surface side of the second die using the liquid medium thus forming the molded body having the predetermined shape.

However, although such a liquid pressure molding device can impart a large deformation amount to the material plate, to impart the large deformation amount to the material plate, it is necessary to uniformly distort the material plate as a whole and hence, there has been a drawback that a shape of the material plate which can be formed is limited.

Particularly, an aluminum alloy has been used recently for reducing the weight of the material place. However, a breakdown limit strain at shearing deformation of the aluminum alloy is small and hence, it is difficult to obtain the sufficient formability even when the above-mentioned liquid pressure molding device is used.

In view of such circumstances, inventors of the present invention have made extensive studies to develop a liquid pressure molding device which can further enhance the formability thus arriving at the present invention.

### SUMMARY OF THE INVENTION

According to an aspect of the invention, there is provided a liquid pressure molding device in which a material plate is clamped by a first die which presses a material plate using a pressurized liquid medium and, a second die which forms a molding recessed surface having a predetermined shape thereon, and the material plate is pressurized by the liquid medium to bring the material plate into contact with the molding recessed surface thus forming a molded body having a predetermined shape, wherein the second die includes a deformation resistance adjusting means which makes the deformation resistance of the material plate different locally. Accordingly, at the time of molding the material plate using the liquid pressure molding device, it is possible to provide the structure which is largely locally deformed to the molded body and hence, a shape of the molded body which can be formed can be made versatile. Particularly, it is possible to perform the integral molding of a plurality of members which has been usually considered impossible.

According to a further aspect of the invention, the deformation resistance adjusting means is constituted of a local cooling means which cools the material plate locally. Accordingly, the strength of a portion of the material plate which is brought into contact with the deformation resistance adjusting means can be enhanced and hence, the resistance of the portion of the material plate against tension from a periphery of the portion can be enhanced whereby the occurrence of breaking of the material plate can be prevented.

According to another aspect of the present invention, the deformation resistance adjusting means is constituted of a local heating means which heats the material plate locally. Accordingly, it is possible to enhance ductility of the portion of the material plate which is brought into contact with the deformation resistance adjusting means and hence, the bulging property of the portion can be also enhanced whereby the generation of breaking of the material plate can be prevented.

According to yet another aspect of the present invention, the deformation resistance adjusting means is allowed to be advanced to or retracted from the second die. Accordingly, by advancing or retracting the deformation resistance adjusting means at the time of performing the molding using the liquid pressure molding device, it is possible to perform the finishing by bulging which uses the deformation resistance adjusting means as a punch and hence, a molded body having more complicated shape can be formed.

According to another aspect of the present invention, the liquid medium is heated to a predetermined temperature and, at the same time, the first die and the second die are also respectively heated to a temperature substantially equal to the temperature of the liquid medium. Accordingly, a molding limit of the material plate can be enhanced by heating the material plate. Further, while the deformation resistance of the material plate can be made approximately uniform as a whole, it is possible to easily form local regions having different deformation resistance using the deformation resistance adjusting means and hence, the formability of the material plate can be enhanced.

According to another aspect of the invention, there is provided a liquid pressure molding method in which a material plate is clamped by a first die which presses a material plate using a pressurized liquid medium and a second die which forms a molding recessed surface having a predetermined shape thereon, and the material plate is pressurized by the liquid medium to bring the material plate into contact with the molding recessed surface thus forming a molded body having a predetermined shape, wherein the deformation resistance of the material plate is made different locally by a deformation resistance adjusting means mounted on the second die. Accordingly, along with the molding of the material plate using the first and second dies, it is possible to form the structure in which the molded body is locally large deformed and hence, it is possible to make a formable shape versatile. Particularly, it is possible to realize the integral molding of a plurality of parts which has been considered impossible usually.

According to yet another aspect of the invention, in the aforementioned liquid pressure molding method, the material plate is locally cooled by the deformation resistance adjusting means. Accordingly, the strength of a portion of the material plate which is brought into contact with the deformation resistance adjusting means can be enhanced and hence, the resistance of the portion of the material plate against tension from a periphery of the portion can be enhanced whereby the occurrence of breaking of the material plate can be prevented.

According to a further aspect of the invention, in the liquid pressure molding method, the material plate is locally heated by the deformation resistance adjusting means. Accordingly, it is possible to enhance ductility of the portion of the material plate which is brought into contact with the deformation resistance adjusting means and hence, the bulging property of the portion can be also enhanced whereby the generation of breaking of the material plate can be prevented.

According to a yet further aspect of the invention, in the aforementioned liquid pressure molding method, the deformation resistance adjusting means is allowed to be advanced to or retracted from the second die. Accordingly, by advancing or retracting the deformation resistance adjusting means at the time of performing the molding the material plate into a predetermined shape by bringing the material plate into contact with the molding recessed surface, it is possible to perform the finishing which uses the deformation resistance adjusting means as a punch and hence, a molded body having more complicated shape can be formed.

According to another aspect of the invention, in the aforementioned liquid pressure molding method, the liquid medium is heated to a predetermined temperature and, at the same time, the first and the second dies are respectively heated to a temperature substantially equal to a temperature of the liquid medium. Accordingly, a molding limit of the material plate can be enhanced along 141 th the heating of the material plate. Further, while the deformation resistance of the material plate can be made approximately uniform as a whole, it is possible to easily form local regions having different deformation resistance using the deformation resistance adjusting means and hence, the formability of the material plate can be enhanced.

According to yet another aspect of the invention, in the aforementioned liquid pressure molding method, the liquid medium is heated to 150 to 350° C. Accordingly, the frictional resistance between the material plate and the second die attributed to a liquid lubricant which is applied between the material plate and the second die can be lowered and hence, the formability of the material plate can be enhanced.

According to a yet further aspect of the invention, in the aforementioned liquid pressure molding method, the material plate is heated using a preheating means before the material plate is clamped between the first die and the second die. Accordingly, time which is required to heat the material plate to the predetermined temperature using the first die and the second die can be shortened and hence, a substantial tact time which is required to form a molded body is shortened so that the productivity of the molded body can be enhanced.

According to another aspect of the invention, in the aforementioned liquid pressure molding method, when the molded body formed by clamping and pressing the material plate using the first die and the second die is made subject to molding by shearing while being placed on a support base having an overlapped surface which is overlapped to the molded body, the molded body is cooled by the support base. Accordingly, the molded body which is heated along with the formation of the molded body is effectively cooled and hence, a generation of burr associated with the molding by shearing can be suppressed.

### BRIEF DESCRIPTION OF THE DRAWINGS

FIG. 1 is a schematic explanatory view of a liquid pressure molding device according to the present invention.

FIG. 2 is a graph showing a temperature dependency of the elongation of an aluminum alloy.

FIG. 3 is a graph showing a temperature dependency of the yield strength of an aluminum alloy.

FIG. 4 is a graph showing a temperature dependency of the tensile strength of an aluminum alloy.

FIG. 5 is an explanatory view which explains a forming process of a material plate using a liquid pressure molding device.

FIG. 6 is an explanatory view which explains a molding step of the material plate using the liquid pressure molding device.

FIG. 7 is an explanatory view which explains a molding step of the material plate using the liquid pressure molding device.

FIG. 8 is an explanatory view which explains a molding step of the material plate using the liquid pressure molding device.

FIG. 9 is an explanatory view which explains a molding step of the material plate using the liquid pressure molding device.

FIG. 10 is an explanatory view which explains a trimming step of the molded body.

FIG. 11 is an explanatory view which explains a trimming step of the molded body.

FIG. 12 is a schematic diagram of a preheating device. FIG. 13 is an explanatory view which explains a preheating step.

FIG. 14 is an explanatory view which explains the preheating step.

FIG. 15 is an explanatory view which explains the preheating step.

### DETAILED DESCRIPTION OF THE INVENTION

A liquid pressure molding device and a liquid pressure molding method according to the present invention are used to form a material plate into a desired shape by clamping the material plate between a first die and a second die. In the second die, a molding recessed surface having a predetermined shape for forming the desired shape is provided and, at the same time, a liquid medium is incorporated in the inside of the first die, wherein the liquid medium is pressurized so that the material plate is pressed toward the molding recessed surface using the liquid medium and the material plate is allowed to be brought into contact with the molding recessed surface thus forming a molded body having a desired shape.

Particularly, the deformation resistance adjusting means which locally varies the deformation resistance of the material plate is provided to the second die and, the material plate is drawn using the first die and the second die with the liquid medium, while the deformation resistance of a part of the material plate which is drawn is locally adjusted using the deformation resistance adjusting means thus enabling the formation of the desired shape.

By providing such a deformation resistance adjusting means, the shapes which can be formed using the liquid pressure molding device can be varied and particularly, it is possible to perform an integral forming of a plurality of parts which is usually impossible.

That is, while performing the drawing of the material plate using the first die and the second die, by locally adjusting the deformation resistance of the material plate using the deformation resistance adjusting means, a bulging processing or a stretching processing can be performed in a combined manner and hence, it is possible to form a molded body having a large deformation amount and a complexed shape.

Hereinafter, the mode for carrying out the present invention is explained in detail in conjunction with the drawings. FIG. 1 is a schematic view of an essential part of a liquid pressure molding device A according to this embodiment.

The liquid pressure molding device A includes a first die 10 and a second die 20 which clamp a material plate 1. made of a metal plate, wherein, in this embodiment, the first die 10 is elevatably placed at a position above the second die 20 and by elevating or lowering the first die 10, the material plate 1 is clamped between the first die 10 and the second die 20.

In the first die 10, a liquid medium containing space 11 to contain a liquid medium 2 is formed, and the liquid medium containing space 11 is closed by a diaphragm 12 which is formed by extending on the lower surface of the first die 10. Further, the liquid medium containing space 11 is communicably connected with a supply pump not shown in the drawing by way of a supplying pipe 13, wherein the liquid medium 2 can be supplied to the liquid medium containing space 11 by pressuring the liquid medium 2 using the supplying pump. By feeding the liquid medium 2 to the liquid medium containing space 11, the diaphragm 12 inflates downwardly as described later so as to press the material plate 1.

Further, by mounting a heating heater not. shown in the drawing on the first die 10, it is possible to heat the first die 10 to a predetermined temperature, and it is possible to heat the liquid medium 2 to a predetermined temperature using a heating heater not shown in the drawing. The liquid medium 2 is heated to the predetermined temperature using the heating heater so that the temperature of the diaphragm 12 which overlaps and bonds with the material plate 1 becomes approximately equal to the temperature of the liquid medium 2.

In the second die 20, a molding recessed surface 21 having a given shape is formed on the upper surface of t:ie second die 20 which overlaps and bonds with the first die 10.

Particularly, a local cooling body 22 and a local heating body 23 are formed at a given position of the molding recessed surface 21. In this embodiment, for facilitating the explanation, one local cooling body 22 and one local heating body 23 are respectively mounted on the second die 20, however, there may be a case in which only the local cooling body 22 is mounted, a case in which only the local heating body 23 is mounted or a case in which a plurality of local cooling body 22 and a plurality of local heating body 23 are respectively mounted, if necessary.

The local cooling body 22 is a local cooling means and a deformation resistance adjusting means which. enlarges the deformation resistance of the region which is cooled by locally cooling the material plate 1. Further, the local. heating body 23 is a local heating means and a deformation resistance adjusting means which reduces the deformation resistance of the region which is heated by locally heating the material plate 1.

By mounting a heating heater not shown in -the drawing on the second die 20, it is possible to heat the second die 20 to a predetermined temperature. In the local cooling body 22, the temperature is set to be lower than the temperature of the second die 20 and, in the local heating body 23, the temperature is set to be higher than the temperature of the second die 20. To be more specific, the local cooling body 22 is cooled by introducing cooling water in the inside thereof and the local heating body 23 is heated using a heating heater not shown in the drawing mounted in the inside of the local heating body 23.

Heat insulators not shown in the drawing are respectively arranged between the local cooling body 22 and the second die 2 and between the local heating body 23 and the second die 2 so that the local cooling body 22 and the local heating body 23 can maintain the predetermined temperature.

Particularly, as shown in the FIG. 1, the local cooling body 22 is arranged in a region of the molding recessed surface 21 which projects upwardly, that is, a region which is brought into contact with the material plate 1 prior to a periphery of the region, while the local heating body 23 is arranged in a region of the molding recessed surface 21 which recesses downwardly, that is, a region which is brought into contact with the material plate 1 after a periphery of the region. By providing the local cooling body 22 and the local heating body 23 in this manner, it is possible to effectively perform a stretching processing or a bulging processing of the material plate 1.

Further, the local cooling body 22 and/or the local heating body 23 can advance or retract with respect to the second die 20. Since the local cooling body 22 and/or the local heating body 23 can advance or retract, the local cooling body 22 and/or the local heating body 23 can be used as a punch and hence, the stretching processing or the bulging processing of the material plate 1 can be performed more effectively.

It maybe possible to reversely arrange the above-mentioned first die 10 and the second die 20 in an upside down state and, in such a case, it is not always necessary to provide the diaphragm 12 to the first die 10.

The formation of the material plate 1 using the liquid pressure molding device A which is formed in this manner is explained hereinafter.

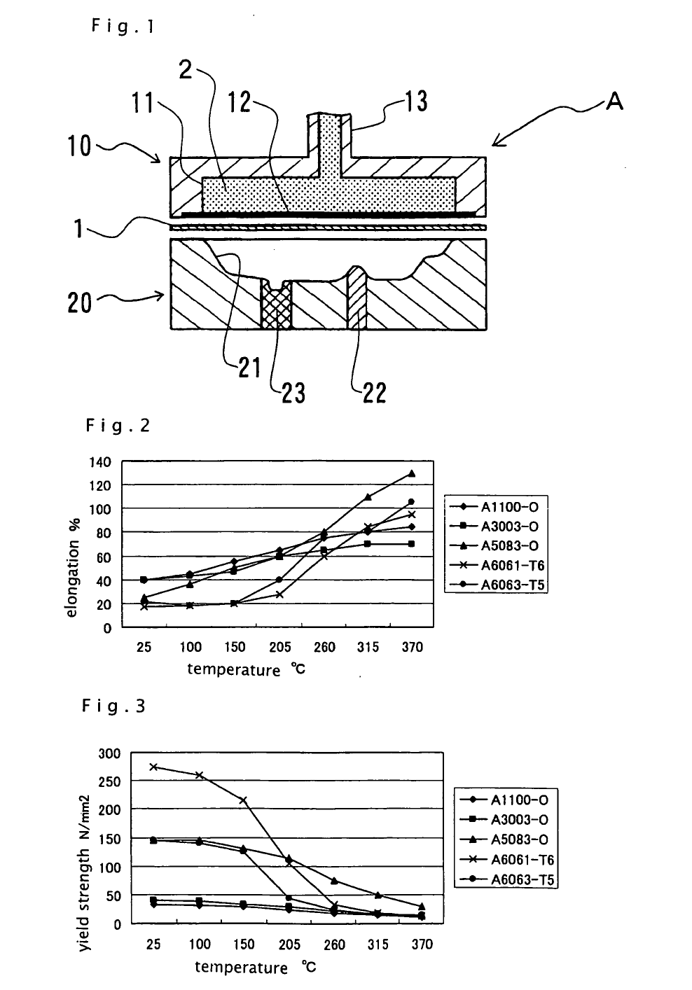

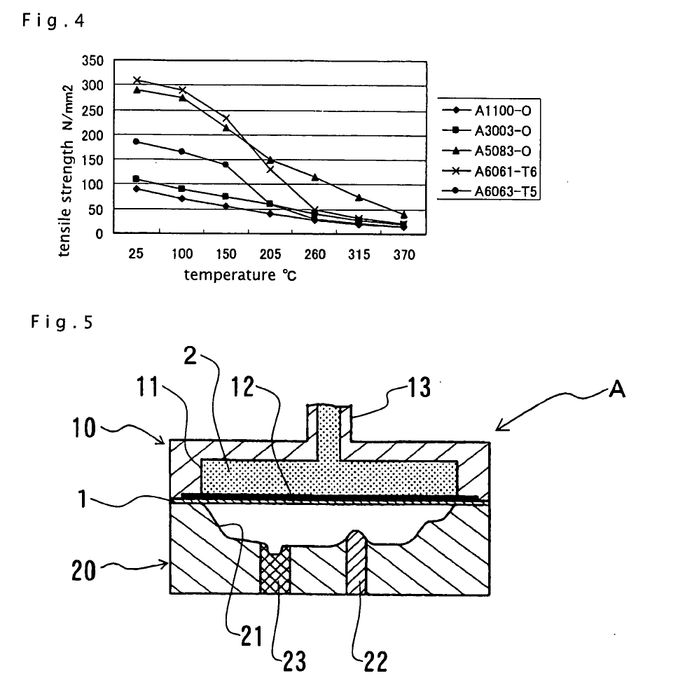

Here, the material plate 1 is a metal plate made of an aluminum alloy. In FIG. 2 to 4, data of the temperature dependencies of elongation, yield strength, tensile strength of five kinds of aluminum alloys (A 1100-0, A3003-0, A5083-0, A6061-T6, A6063-T5) is shown. When the aluminum alloy is heated to 150° C. or more, the elongation of the aluminum alloy is enhanced and the yield strength and the tensile strength are deteriorated so that it is possible to perform drawing of the aluminum alloy, therefore, it is preferable to heat the material plate 1 to 150° C. or more.

However, although it is possible to perform the drawing of the material plate 1 even when the material plate 1 is heated to 350° C. or more, the metal crystal of the material plate 1 made of a metal plate becomes coarse thus easily generating the lowering of the hardness of the material plate 1 and, at the same time, the selection of a liquid lubricant (not shown in the drawings) which is applied between the material plate 1 and the second die 20 becomes difficult. Accordingly, it is not realistic to heat the material plate to 350° C. or more and it is preferable to heat the material plate 1 at a temperature between 150° C. and 350° C. So long as the material plate 1 is heated at the temperature within this temperature range, the coarsening of the metal crystals can be suppressed and hence, it is possible to apply the liquid pressure molding device A of the present invention to the material plate 1 made of superplastic metal and the like which contains fine metal crystals. Further, the frictional resistance between the material plate 1 and the second die 20 attributed to the liquid lubricant can be lowered and hence, the formability of the material plate can be enhanced.

Accordingly, in this embodiment, the liquid medium 2 is heated at approximately 200° C. to 300° C. and the first die 10 and the second die 20 are respectively heated at approximately 200° C. to 300° C. in the same manner as the liquid medium. By heating the liquid medium 2, the first die 10 and the second die 20 respectively at substantially same temperature, the material plate 1 is uniformly heated as a whole and hence, the deformation resistance of the material plate 1 can be made approximately uniform as the whole.

Further, the local cooling body 22 mounted on the second die 20 is adjusted so that the temperature of the local cooling body 22 becomes lower than the temperature of the second die 20 by approximately 50° C. On the other hand, the local heating body 23 mounted on the second die 20 is adjusted so that the temperature of the local heating body 23 becomes approximately 50° C. higher than the temperature of the second die 20. Here, the temperature difference between the local cooling body 22 and the local heating body 23 and the second die 20 is not limited to approximately 50° C. and the temperature difference may be set higher or lower than 50° C. to conform to the material of the material plate 1.

In this embodiment, the explanation is made with respect to the case in which the material plate 1 is the metal plate made of aluminum alloy. However, the material plate 1 is not limited to the aluminum alloy and this embodiment is applicable to any proper metal plate. In this embodiment, to explicitly show that this embodiment is also applicable to the aluminum alloy which cannot be molded by the conventional molding device due to the small breaking limit strain, the explanation is made with respect to the case in which material plate 1 is made of a metal plate made of aluminum alloy.

As shown in FIG. 5, in the liquid pressure molding device A, the material plate 1 is clamped between the first die 10 and the second die 20 which are heated at the predetermined temperature, and the diaphragm 12 is overlapped to the material plate 1 so as to heat the material plate 1 at approximately 200° C. to 300° C. The material plate 1 made of aluminum alloy has the relatively high heat conductivity and hence, it is possible to heat the material plate 1 to a desired temperature in an extremely short time.

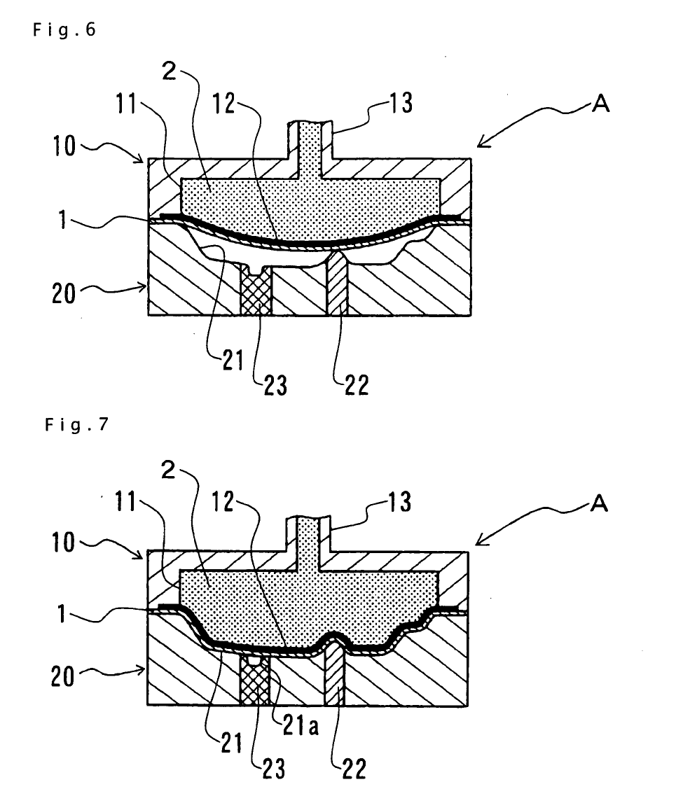

Further, after a time sufficient for allowing the material plate 1 to reach a predetermined temperature elapses, the liquid medium 2 is supplied to the liquid medium containing space 11 using the supply pump so as to, as shown in the FIG. 6, push down the material plate 1 by way of the diaphragm 12. Here, a peripheral portion of the material plate 1 is clamped while being heated by the first die 10 and the second die 20 and hence, it is possible to prevent the formation of wrinkles on the material plate 1.

When a portion of the material plate 1 is brought into contact with the local cooling body 22 of the second die 20 due to the downward pushing of the material plate 1 by way of the diaphragm 12 as shown in FIG. 6, a contact portion cf the material plate 1 is cooled by the local cooling body 22 and hence, a strength of the contact portion of the material plate 1 is enhanced whereby the deformation resistance of the contact portion is increased.

Accordingly, the portion of the material plate 1 which comes into contact with the local cooling body 22 can enhance the resistance against tension from a periphery of the portion and hence, it is possible to prevent the occurrence of the. breaking of the material plate 1.

In this manner, by forming the portion which can enhance the resistance against the tension in a region which projects above the molding recessed surface 21 and hence, it is possible to form a convex shape or a concave shape as viewed reversely on the material plate 1 without generating the breaking of the material plate 1.

In the liquid pressure molding apparatus A, by further supplying the liquid medium 2 under pressure into the inside of the liquid medium containing space 11 using the supply pump, the material plate 1 is further pushed down by way of the diaphragm 12 and, as shown in FIG. 7, the material plate 1 is brought into contact with the molding recessed surface 21 also at positions besides the local cooling body 22.

Here, at a portion of a minute concave-shaped region 21a formed on the molding recessed surface 21, the material plate 1 is not brought into contact with the molding recessed surface 21 and hence, it is necessary to further supply the liquid medium 2 under pressure into the inside of the liquid medium containing space 11.

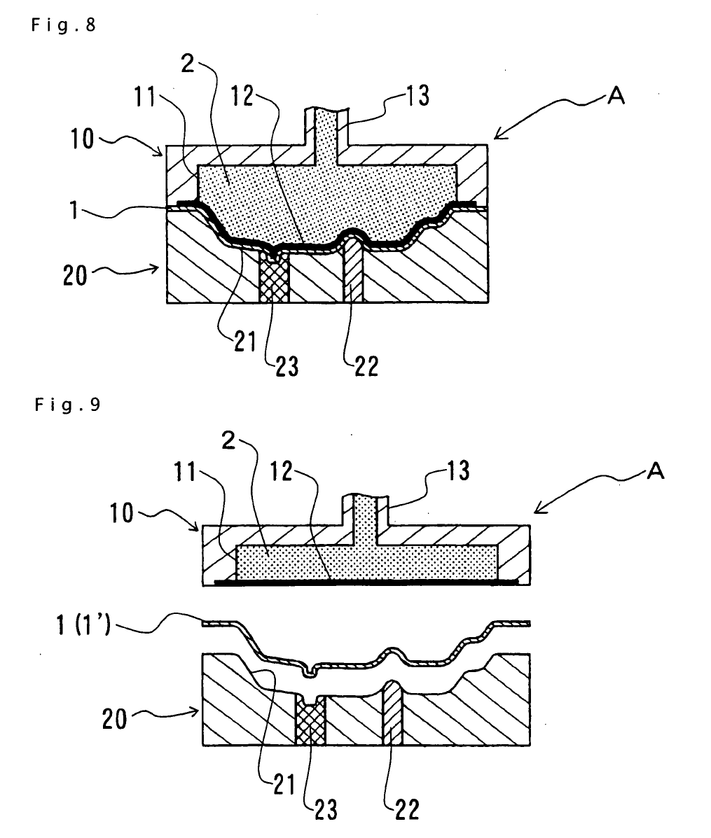

As described above, since the concave-shaped region 21a is constituted of the local heating body 23, due to the heating by the local heating body 23, the material plate 1 which comes into contact with a periphery of the concave-shaped region 21a has ductility thereof enhanced whereby the deformation resistance of the material plate 1 is decreased and the stretching property thereof is enhanced. Accordingly, as shown in FIG. 8, it is possible to relatively easily form the material plate 1 into the given concave shape or the convex shape as viewed reversely by bringing the material plate 1 into contact with the molding recessed surface 21 of the concave-shaped region 21a without generating the breaking of the material plate 1.

Further, in such a state that the material plate 1 is brought into contact with the molding recessed surface 21, by allowing the local cooling body 22 and/or the local heating body 23 to advance to or retract from the second die 20, it is possible to more effectively perform the stretch processing and the bulge processing of the material plate 1 using the local cooling body 22 and/or the local heating body 23 as a punch.

Here, whether the molding of the material plate 1 is completed or not is determined based on the pressure which is pressurized due to the supply of the liquid medium 2 into the inside of the liquid medium containing space hand a total supply flow rate of the liquid medium 2.

When the molding of the material plate 1 is completed, the pressurization of the liquid medium 2 in the inside of the liquid medium containing space 11 is released so as to elevate the first die 10 thus allowing the removal of the material plate 1 which is formed into a given molded body 1′ as show in FIG. 9.

Usually, a blank remains in a peripheral portion of the molded body 1′ which is molded in the above-mentioned manner and hence, after molding the molded body into a predetermined shape by the liquid pressure molding device A, the trimming which removes the blank by shearing is performed using a shearing device B which is schematically shown in FIG. 10 thus forming the complete molded body 1.

Particularly, with respect to the shearing device B of this embodiment, an upper surface of the support base 30 which places the molded body 1′ thereon is formed as a recessed overlapping surface 31 which is overlapped with the molded body 1′ thus enabling the stable supporting of the molded body 1′. Furthermore, a suitable cooling mechanism is provided to the support base 30 thus cooling the molded body 1′ by the support base 30 when the molded body 1′ is placed on the support base 30.

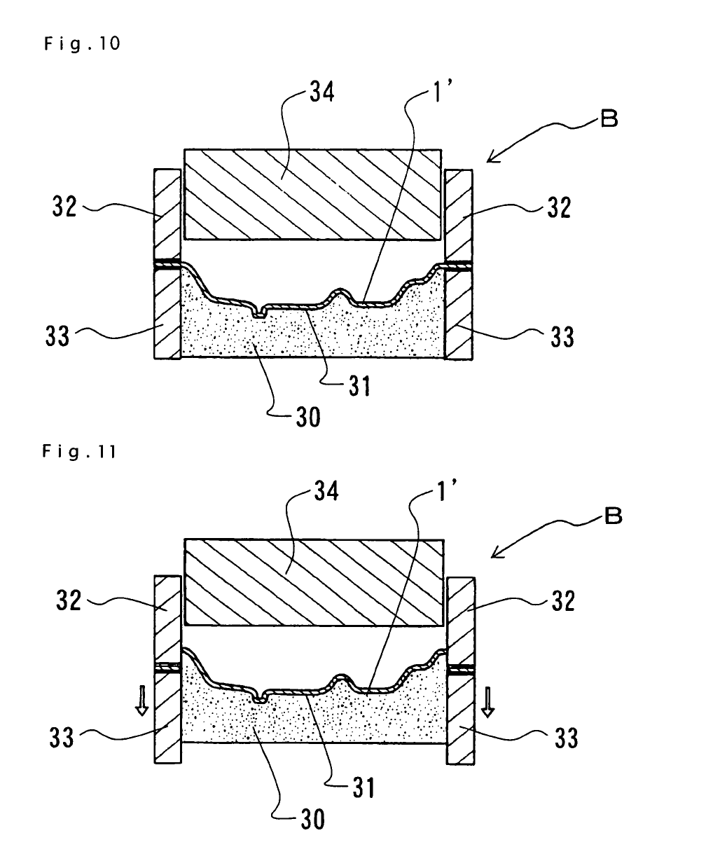

Accordingly, it is possible to efficiently cool the molded body 1′ which is heated by the liquid pressure molding device A and hence, the ductility of the molded body 1′ is lowered whereby, as shown in FIG. 11, the trimming can be performed using a shearing punch 32 thus suppressing the generation of burrs. In FIG. 10 and FIG. 11, numeral 33 indicates a blank support. base which supports the blank, and numeral 34 indicates a guide body for the shearing punch 32. The blank support base 33 is elevated or lowered following an operation of the shearing punch 32.

The cooling mechanism which cools the support base 30 maybe configured such that cooling water is introduced into the support base 30 so as to cool the molded body 1′.

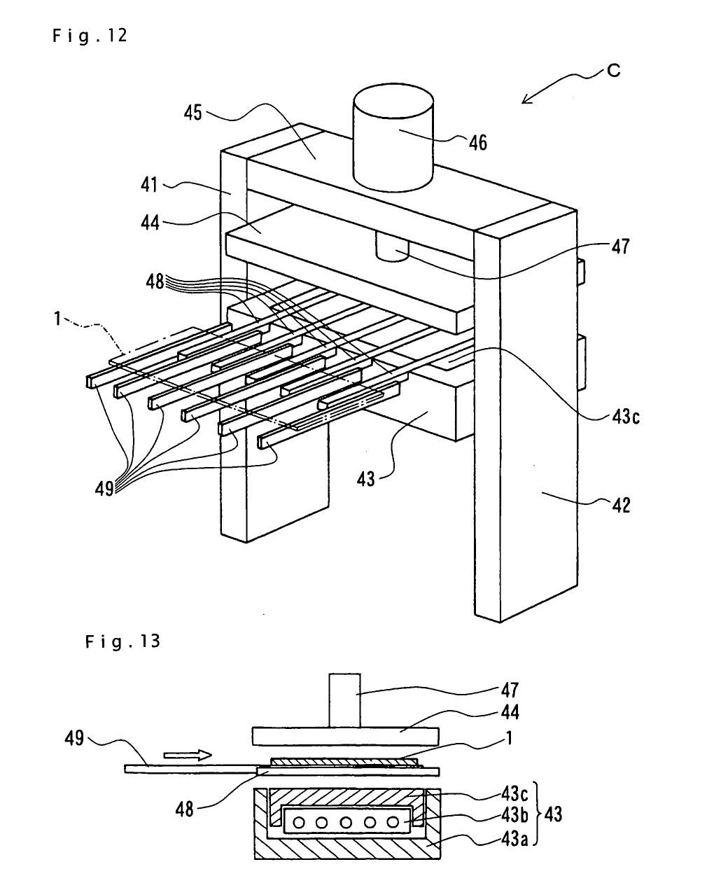

In molding the material plate 1 using the above-mentioned liquid pressure molding device A, when the heating temperature of the material plate 1 attributed to the diaphragm 12, the first die 10 and the second die 20 of the liquid pressure molding device A is high, the material plate 1 may be preliminarily heated to a predetermined temperature using a preheating device C shown in FIG. 12. Here, by taking the natural cooling of the material plate 1 during the transportation from the preheating device C to the liquid pressure molding device A into consideration, it is preferable that the preheating device C is heated to a temperature higher than the heating temperature of the material plate 1 due to the liquid pressure molding device A. Here, the preheating device C constitutes a preheating means.

Since the material plate 1 is heated to the predetermined temperature by the preheating device C, the time necessary for heating the material plate 1 to the predetermined temperature by the diaphragm 12, the first die 10 and the second die 20 can be shortened and hence, a substantial tact time necessary for forming the molded body 1′ can be shortened thus enhancing the productivity.

The preheating device C of this embodiment is provided with a dedicated or exclusive-use transport mechanism for enabling the handling of the large-sized material plate 1 which is liable to be easily deflected during the transportation. The preheating device C is explained hereinafter.

In the preheating device C, as shown in FIG. 12, a heating portion 43 is extended between a first support strut 41 and a second support strut 42, and the material plate 1 is placed on an upper surface of the heating portion 43 thus enabling the heating of the material plate 1.

Further, at a position above the heating portion 43, a pusher plate 44 which pushes down the material plate 1 placed on the heating portion 43 to the heating portion 43 so as to enhance the heating efficiency is arranged, and the pusher plate 44 is mounted on a distal end of a rod 47 of a lift cylinder 46 which is mounted on an upper frame 45 extended between upper ends of the first support strut 41 and the second support strut 42 thus allowing the pusher plate 44 to be elevated or lowered. Particularly, the pusher plate 44 is formed of a soft elastic material and hence, the pusher plate 44 can push down the whole surface of the material plate 1 to the heating portion 43 substantially uniformly.

In this embodiment, the heating portion 43 is, as shown in FIG. 13 to FIG. 15, constituted of a box-shaped heat insulating shell 43a which forms a heating heater accommodating space therein and has an upper portion thereof open-ended, a heating heater 43b which is arranged in the inside of the heating heater accommodating space, and a hot plate 43c which is heated by the heating heater 43b.

Between the first support strut 41 and the second support strut 42 and above the heating portion 43, a plurality of rod-like lift arms 48 are arranged in parallel thus forming a support surface for the material plate 1. The lift arms 48 are elevated or lowered by a lift mechanism not shown in the drawing, wherein when the lift arms 48 are lowered, the respective lift arms 48 are inserted into insertion grooves formed in an upper surface of the hot plate 43c and hence, the material plate 1 which is placed on the upper surfaces of the lift arms 48 can be placed on the hot plate 43c.

Further, as a feeding means which feeds the material plate 1 to the lift arms 48, a feeding mechanism which constitutes a support surface by arranging a plurality of transport arms 49 which extend substantially parallel to the extending direction of the rod-like lift arms 48 in parallel is provided. Each transport arm 49 can be inserted between two neighboring lift arms 48, 48, and the transport mechanism which is constituted of the transport arms 49 is operated as follows due to proper lift mechanism and horizontal moving mechanism.

First of all, the transport arms 49 are positioned at an initial position as shown in FIG. 12, and the material plate 1 which is transported by a suitable transport means is placed on the support surface formed by the transport arms 49 in place.

Next, as shown in FIG. 13, the transport arms 49 are moved to a position above the heating portion 43 so as to position the material plate 1 above the heating portion 43. Here, by positioning the respective transport arms 49 higher than the lift arms 48, there is no possibility that the lift arms 48 become an obstacle and hence, material plate 1 can be positioned above the heating portion 43.

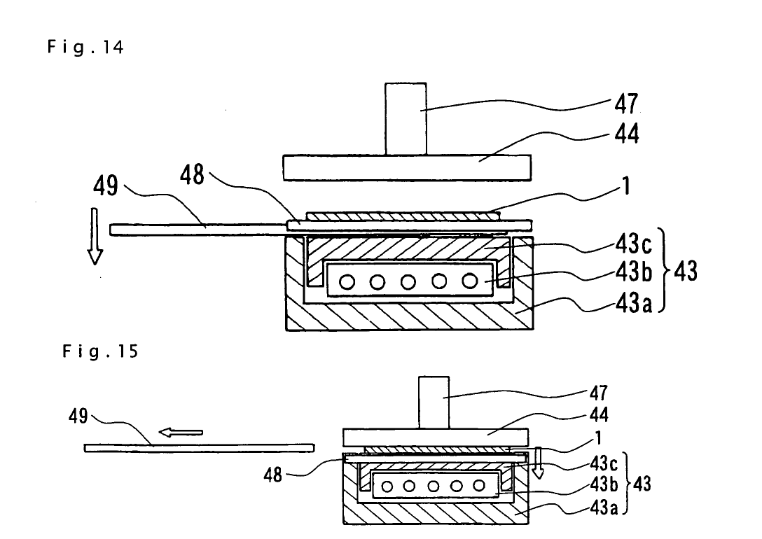

Next, as shown in FIG. 14, by lowering the transport arms 49, the material plate 1 is placed on the lift arms 48 from the transport arms 49. Here, in place of lowering the transport arms 49, the lift arms 48 may be elevated so as to place the material plate 1 on the lift arm 48.

After placing the material plate 1 on the lift arm 48, as shown in FIG. 15, the transport arms 49 are retracted from an upper region of the heating portion 43 due to the translational movement of the transport arms 49, and the lift arms 48 are lowered so as to place the material plate 1 on the hot plate 43c. Further, by lowering the pusher plate 44 so as to allow the pusher plate 44 to push the material plate 1, the material plate 1 is heated by the heating portion 43.

After the material plate 1 is heated to the predetermined temperature by the heating portion 43, by performing operations opposite to the above-mentioned operations, the material plate 1 is taken out. The material plate 1 which is taken out from the heating portion 43 is transferred to the liquid pressure molding device A using a suitable transport means.

### INDUSTRIAL APPLICABILITY

In molding the metal plate having a large area into a predetermined shape by liquid pressure molding, it is possible to perform the molding in more versatile shapes. Particularly, it is possible to realize the integral molding of a plurality of members.

1. A liquid pressure molding device in which a material plate is clamped by a first die which presses a material plate using a pressurized liquid medium and a second die which forms a molding recessed surface having a predetermined shape thereon, and the material plate is pressurized by the liquid medium to bring the material plate into contact with the molding recessed surface thus forming a molded body having a predetermined shape, wherein the second die includes a deformation resistance adjusting means which makes the deformation resistance of the material plate different locally.

2. A liquid pressure molding device according to claim 1, wherein the deformation resistance adjusting means is constituted of a local cooling means which cools the material plate locally.

3. A liquid pressure molding device according to claim 1, wherein the deformation resistance adjusting means is constituted of a local heating means which heats the material plate locally.

4. A liquid pressure molding device according to any one of claims 1 to 3, wherein the deformation resistance adjusting means is allowed to be advanced to or retracted from the second die.

5. A liquid pressure molding device according to any one of claims 1 to 3, wherein the liquid medium is heated to a predetermined temperature and, at the same time, the first die and the second die are also respectively heated to a temperature substantially equal to the temperature of the liquid medium.

6. A liquid pressure molding method in which a material plate is clamped by a first die which presses a material plate using a pressurized liquid medium and a second die which forms a molding recessed surface having a predetermined shape thereon, and the material plate is pushed by pressurizing the liquid medium to bring the material plate into contact with the molding recessed surface thus forming a molded body having a predetermined shape, wherein the deformation resistance of the material plate is made different locally by a deformation resistance adjusting means mounted on the second die.

7. A liquid pressure molding method according to claim 6, wherein the material plate is locally cooled by the deformation resistance adjusting means.

8. A liquid pressure molding method according to claim 6, wherein the material plate is locally heated by the deformation resistance adjusting means.

9. A liquid pressure molding method according to any one of claims 6 to 8, wherein the deformation resistance adjusting means is allowed to be advanced to or retracted from the second die.

10. A liquid pressure molding method according to any one of claims 6 to 8, wherein the liquid medium is heated to a predetermined temperature and, at the same time, the first and the second dies are respectively heated to a temperature substantially equal to a temperature of the liquid medium.

11. A liquid pressure molding method according to claim 10, wherein the liquid medium is heated to 150 to 350° C.

12. A liquid pressure molding method according to claim 11, wherein the material plate is heated using a preheating means before the material plate is clamped between the first die and the second die.

13. A liquid pressure molding method according to claim 12, wherein when the molded body formed by clamping and pressing the material plate using the first die and the second die is made subject to molding by shearing while being placed on a support base having an overlapped surface which is overlapped to the molded body, the molded body is cooled by the support base.
